(19) United States
(12) Patent Application Publication
(10) Pub. No.: US 2026/0159235 A1
(43) Pub. Date: Jun. 11, 2026

(54) MODULAR VERTICAL TAKE-OFF AND LANDING (VTOL) AIRCRAFT SYSTEM AND METHOD

(71) Applicant: Corvidair Inc., Walnut, CA (US)

(72) Inventors: Star Simpson, Covina, CA (US); Barnaby Wainfan, Independence, OR (US)

(21) Appl. No.: 18/087,136

(22) Filed: Dec. 22, 2022

Related U.S. Application Data
(60) Provisional application No. 63/293,806, filed on Dec. 26, 2021.

(51) Int. Cl. B64C 29/00; B64D 29/00

(52) U.S. Cl. CPC B64C 29/0091; B64C 29/0025; B64D 29/00; B64C 2211/00

(57) ABSTRACT

A modular aircraft system comprising a plurality of nacelles and a plurality of wing segments. The modular aircraft system is modularly configurable into a plurality of different configurations with pairs of the plurality of nacelles connected via respective wing segments of the plurality of wing segments to generate an annular wing that defines a wing cavity.

### CROSS-REFERENCE TO RELATED APPLICATIONS

This application is a non-provisional of and claims the benefit of U.S. Provisional Application No. 63/293,806, filed Dec. 26, 2021, entitled “MODULAR VERTICAL TAKE-OFF AND LANDING (VTOL) AIRCRAFT.” This application is hereby incorporated herein by reference in its entirety and for all purposes.

### BRIEF DESCRIPTION OF THE DRAWINGS

FIG. 1 depicts a front isometric view of an aircraft in accordance with an example embodiment.

FIG. 2 depicts a rear isometric view of the example aircraft of FIG. 1.

FIG. 3 depicts a side view of the example aircraft of FIGS. 1 and 2.

FIG. 4 depicts a side view of the example aircraft of FIGS. 1-3.

FIG. 5 depicts an example embodiment of a modular aircraft in accordance with an embodiment.

FIGS. 6A and 6B depict a first and second isometric view of a nacelle having coupling faces on opposing sides of the nacelle body that allow one or more wing segments to be coupled to the nacelle.

FIG. 7A is a side view of a nacelle comprising a coupling face having coupling faces on opposing sides of the nacelle body that allow one or more wing segments to be coupled to the nacelle.

FIG. 7B is a front view of a nacelle comprising a coupling face having coupling faces on opposing sides of the nacelle body that allow one or more wing segments to be coupled to the nacelle.

FIG. 8 illustrates another example embodiment of an aircraft defined by six nacelles and six wing segments.

FIG. 9 illustrates an example embodiment of an aircraft having an annular ring that defines an oval shape having an oval ring cavity, with the aircraft being defined by four nacelles and four wing segments.

FIG. 10 illustrates an example of an aircraft taking off in a vertical orientation, transitioning to a horizontal orientation for flight, and then transitioning to a vertical orientation for landing.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

The present disclosure generally relates to Vertical Takeoff and Landing (VTOL) and other aircraft, including annular-wing and multi-rotor VTOL aircraft. While quadrotor drones are in common use, such systems are single-configuration vehicles that do not share common parts or assemblies and can only be produced in a single embodiment. None of the existing annular-wing multi-rotor vehicles have a modular, multi-configuration capability. There is a need in the art to maximize, optimize, and improve modularity and for the ability to produce a wide variation of vehicles from a modular common set of parts.

Various embodiments herein relate to a modular VTOL multirotor aircraft using motor nacelles connected by wing segments to form an annular wing. Different configurations can be created by connecting together different numbers of modules, or by using wing segments of differing lengths. In some embodiments, the aircraft takes off and lands using the thrust of the rotors like a drone multirotor. Once airborne, in various examples, the aircraft can pitch to a nearly horizontal attitude and fly supported by the aerodynamic lift of the annular wing. The rotors can then propel the aircraft forward only in some examples, thus reducing the power required to fly, as compared to flying like a rotorcraft being supported by motor/rotor thrust.

Various embodiments include an annular wing with a number of segments (e.g., four), with propulsive motors (e.g., four) mounted at intervals in nacelles or pods around the perimeter of the wing. In a preferred embodiment, the motors are electric and drive rotors or propellers. The wing in various examples forms a closed curve or polygon in front view and has an airfoil cross section to provide lift in forward flight. The motors/rotors can provide thrust for takeoff and landing and forward propulsion and control in flight. A center body may be connected to the wing via struts.

Different configurations can be created by connecting together different numbers of nacelles and wing segments, or by using wing segments of differing lengths and/or shapes to produce a variety of aircrafts of differing size and configuration using a set of common parts (motor nacelles, motors, and wing segments). Modular buildup of multiple vehicle wing and motor configurations can include combining nacelle/motor units and wing segments. In one embodiment, four motor nacelles are connected with two straight wings segments and two curved wing segments, forming an oval in front view. In another embodiment, six motor nacelles are connected with six curved wing segments, forming a circle in front view.

Wing segments may be straight in front view so that the closed curve of the annular wing is a polygon or can be segments of a circle in front view so that the closed curve of the annular wing is a circle or ellipse. Straight and curved segments may be combined to produce differing configurations of an annular wing. For example, a configuration of the wing in front view can be composed of multiple straight segments closed in front to form a polygon (octagon, hexagon, rectangle, etc.), or the height and width in front view of the wing could be different (e.g., forming a rectangle, ellipse, or flattened polygon).

In some embodiments, three or more propulsive motors can be mounted at intervals around the perimeter of the wing, or to struts within the inner “tube” of the wing. The motors may be mounted directly to the wing or in nacelles or pods attached to the wing or attached to the struts inside the wing perimeter. The motors can be electric or internal combustion motors driving rotors. Where the aircraft includes a center body, additional propulsive elements to propel the vehicle in forward flight can be present on or about the center body in some examples to improve performance in forward flight. The motor configuration may be either tractor or pusher, and motors may be internal combustion engine (“ICE”) rather than electric in some embodiments. In addition, ducted fans could be used instead of propellers in some examples. Various wing/motor/rotor combinations can be used either as a complete vehicle or in combination with a center body attached to the wing and/or nacelles by struts. Wing segments and nacelles can be combined into single modular assemblies in various embodiments.

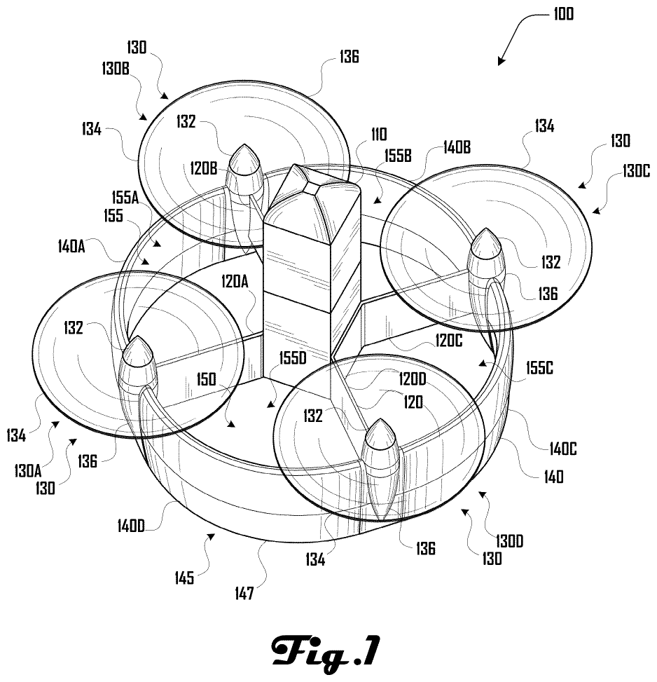

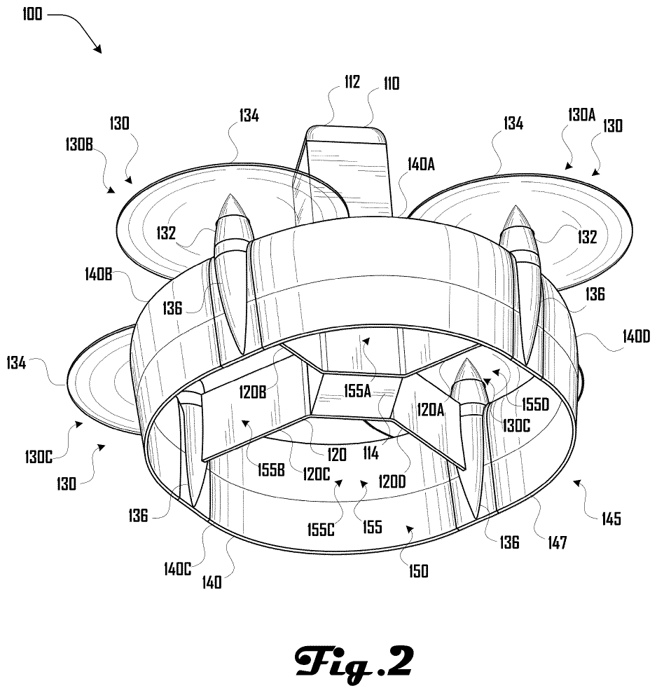

Turning to FIGS. 1-4, an example embodiment of an aircraft 100 is illustrated that comprises a central body 110 with a plurality of struts 120 extending from the central body 110 that connect the central body 110 with a plurality of respective nacelles 130. Pairs of the nacelles 130 are connected via respective wing segments 140 to define an annular wing 145. The annular wing 145 defines wing cavity 150 in which the central body 110 and struts 120 are disposed, with the struts 120 and wing segments 140 defining respective wing cavity portions 155.

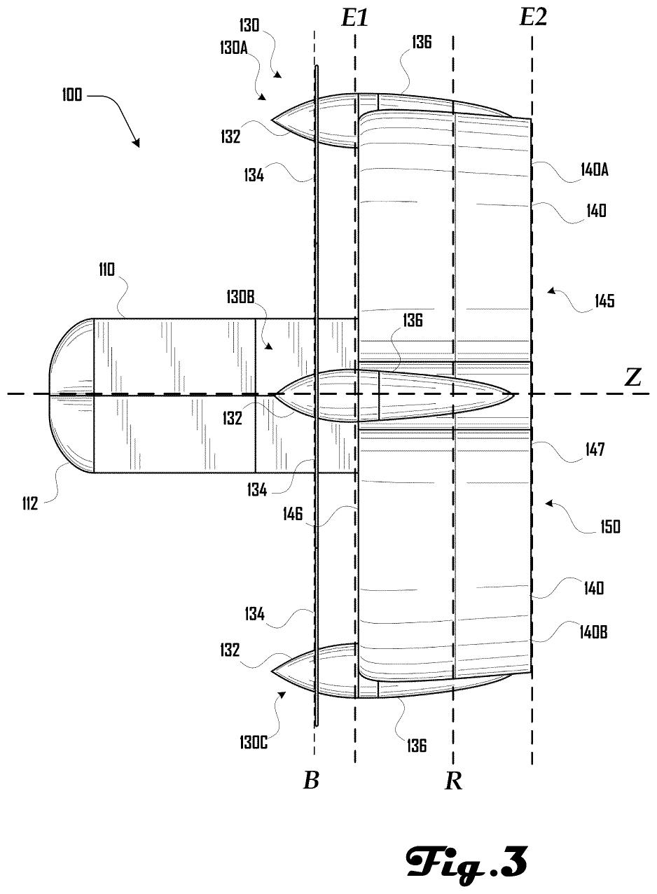

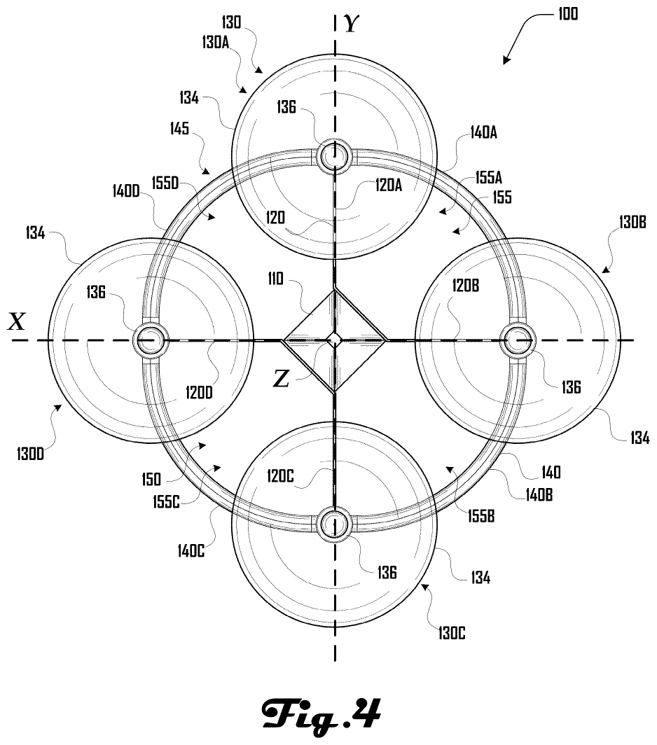

As shown in the example embodiment of FIGS. 1-4, the aircraft 100 has four nacelles 130A, 130B, 130C, 130D that are connected by four wing segments 140A, 140B, 140C, 140D to define an annular wing 145 that is generally circular. As shown in FIG. 4, first and third nacelles 130A, 130C can be aligned along a common plane or axis Y, with second and fourth nacelles 130B, 130D disposed along a common plane or axis X that is perpendicular to axis Y. As shown in FIGS. 3 and 4, the central body 110 can have a main axis Z that is coincident with and perpendicular to the intersection of axes X and Y. In various embodiments, the aircraft 100 can have symmetry about axis X and axis Y.

The nacelles 130 can comprise a motor 132 with a plurality of blades 134 rotatably extending therefrom with the motor 132 enclosed within a nacelle body 136. Spinning of the blades 134 can generate lift and/or propulsion as discussed herein. In various embodiments, any suitable number of blades 134 can be present extending from the motor 132 such as 2, 3, 4, 5, 6, 7, 8, 9, 10, 12, 18, 24, 36, 48, 72 or the like. For purposes of clarity, in various illustrations herein, the plurality or blades 134 are shown spinning such that the individual blades 134 are not explicitly shown. In some embodiments, the motors 132 can be electric motors; however, in further embodiments any suitable type of motor can be used, such as an internal combustion engine (ICE), or the like. Batteries and/or fuel tanks could be mounted in one or more nacelle 130, wing segment 140 wing, dedicated pods, or the like.

As shown in FIG. 3 in some embodiments, the motors 132 of the nacelles 130 can be configured such that the blades 134 of respective nacelles 130 are disposed within a common plane B, which can be perpendicular to axis Z. Additionally, the annular wing 145 can have a central ring plane R with respective first and second edges 146, 147 of the annular wing 145 defining respective edge planes E1, E2 that are parallel to each other and central ring plane R.

In various embodiments the central body 110 can be an elongated member with a square profile along axis Z and a rounded first tip 112. The central body 110 can be held within the center of the wing cavity 150 via the struts 120 such that the central body 110 extends past the first edge plane El of the annular wing 145 with a second end 114 of the central body being disposed within the wing cavity 150 between the first and second edge planes E1, E2.

In various embodiments, the struts 120 can be planar members extending from respective edges of the central body 110 to the nacelles 130 with a main plane of the struts 120 being parallel to axis Z of the central body 110. However, in further embodiments, struts 120 can be various suitable elements of various suitable shapes, such as being in the shape of an airfoil, comprising a plurality of bars, trusses, or the like.

In various embodiments, the wing segments 140 can have an airfoil profile or other suitable profile, such as being planar, oval or the like. In some embodiments, an aircraft 100 can have four wing segments 140A, 140B, 140C, 140D as shown FIGS. 1-4, but further embodiments can have any suitable number of wing segments 140 including 2, 3, 4, 5, 6, 7, 8, 9, 10, 12, 18, 24, 36, 48, 72 or the like. Also, in various embodiments, the wing segments 140 can be the same shape, but in some embodiments, the wing segments 140 can be different shapes as discussed in more detail herein.

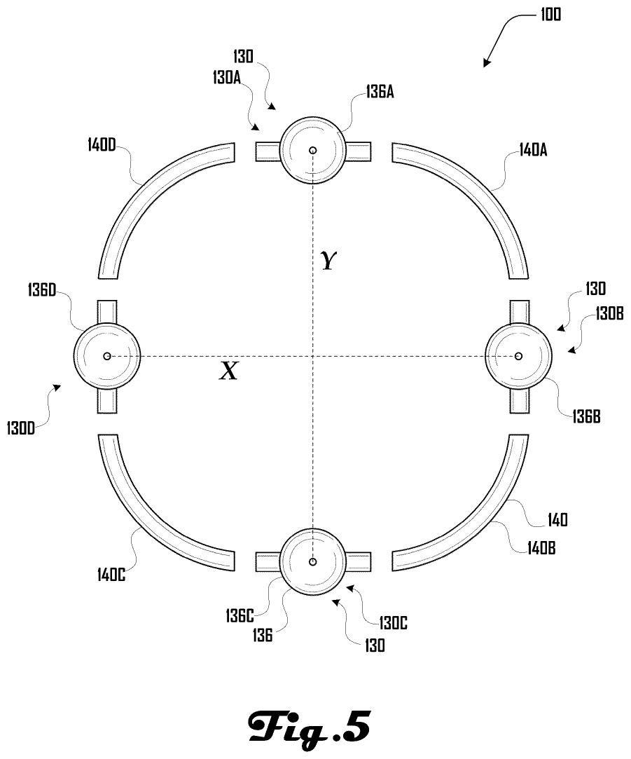

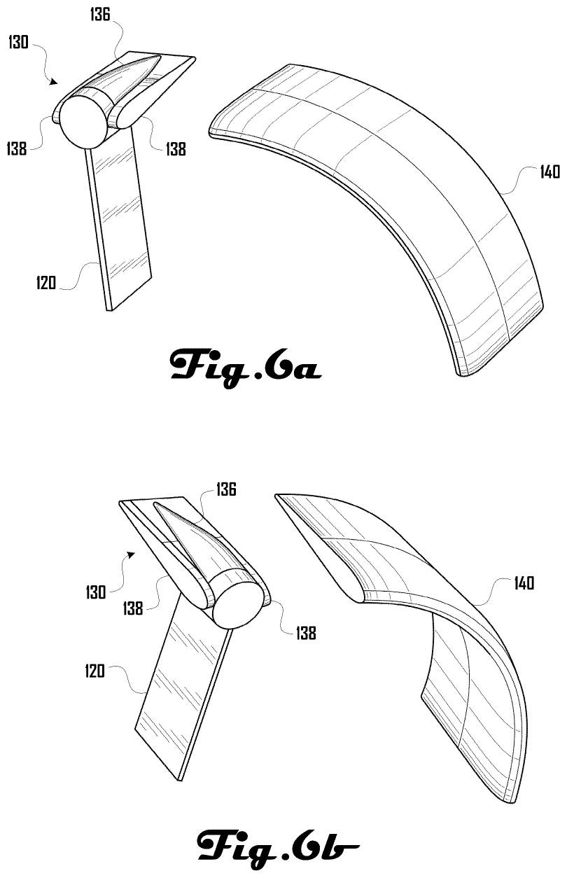

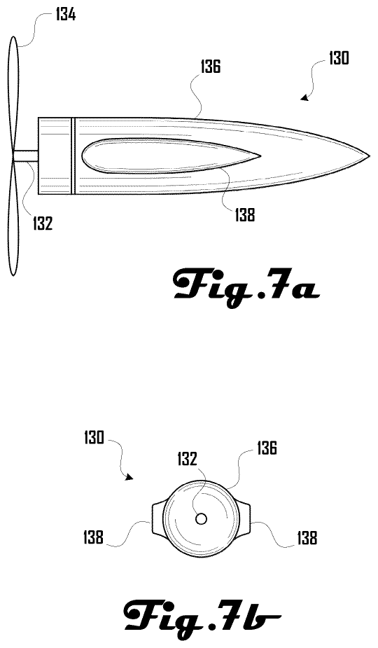

In various embodiments, the wing segments 140 can be removably coupled to the nacelles 103 such that the aircraft 100 can be readily assembled/disassembled and/or modularly configurable into different configurations of an aircraft 100. For example, FIG. 5 illustrates an example configuration where four arced wing segments 140A, 140B, 140C, 140D are separated from four nacelles 130A, 130B, 130C, 130D. Such wing segments 140 and nacelles 130 can be coupled together to generate an aircraft 100 such as shown in FIGS. 1-4. For example, FIGS. 6a, 6b, 7a and 7b illustrate an example of a nacelle 130 having coupling faces 138 on opposing sides of the nacelle body 136 that allow one or more wing segments 140 to be coupled to the nacelle 130. Such a coupling between a nacelle 130 and wing segment 140 can be via any suitable elements such as a slot, pin, socket, bolt, latch, magnet, glue, weld, or the like.

In some examples, nacelles 130 and/or wing segments 140 can be completely modular. For example, using FIGS. 1-5 as an illustration, four nacelles 130A, 130B, 130C, 130D can be disposed clockwise in order to define the annular wing 145 of the aircraft 100 and four wing segments 140A, 140B, 140C, 140D can also be disposed clockwise in order about to define the annular wing 145 of the aircraft 100. However, in various embodiments, any of the nacelles 130 can be disposed in any suitable clockwise order to define the annular wing 145 of the aircraft 100 (e.g., 130A, 130B, 130D, 130C or 130D, 130C, 130B, 130A or 130D, 130B, 130A, 130C or the like). Similarly, in various embodiments any of the wing segments 140 can be disposed in any suitable clockwise order to define the annular wing 145 of the aircraft 100 (e.g., 140A, 140B, 140D, 140C or 140D, 140C, 140B, 140A or 140D, 140B, 140A, 140C or the like).

Such modularity can be desirable by allowing an aircraft 100 to be constructed without regard for nacelles 130 and/or wing segments 140 being in any specific order with any such elements being usable equivalently to another one of such elements. Additionally, having modular elements can allow for damaged parts to be easily replaced by equivalent ones without regard for the specific location in a configuration of an aircraft 100 where the element will be disposed.

While the examples of FIGS. 1-5 illustrate embodiments where the wing segments 140 define arcs of about 90°, wing segments 140 of further embodiments can define any suitable arc such as 180°, 120°, 90°, 72°, 180°, 60°, 45°, 40°, 36°, 30°, 22.5°, and the like, or a range between such example values. In various embodiments, the arc of a set of wing segments 140 can correspond to the number of wing segments 140 and nacelles 130 that will define an annular wing 145. For example, a set of four wing segments 140 that are each 90° and four nacelles 130 can be used to generate a generally circular annular ring 145 of 360°, with the nacelles 130 defining linear portions of the annular ring 145 (see e.g., FIGS. 1-5).

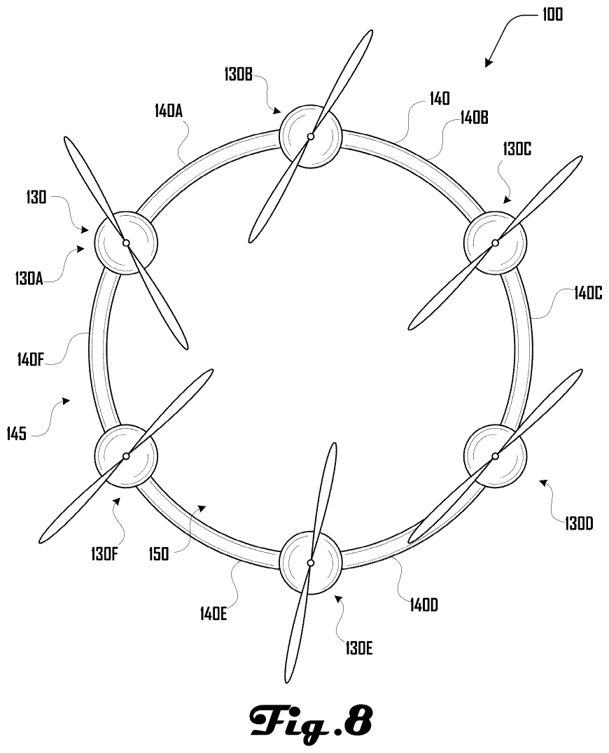

FIG. 8 illustrates another example embodiment of an aircraft 100 defined by six nacelles 130A, 130B, 130C, 130D, 130E, 130F and six wing segments 140A, 140B, 140C, 140D, 140E, 140F. In such an example, the six wing segments 140 can each be an arc of 60°, to generate a generally circular annular ring 145 of 360°, with the nacelles 130 defining linear portions of the annular ring 145. However, in some embodiments, nacelles 130 can be configured to define an arched portion of or an annular ring 145 with the wing segments being sized accordingly. For example, nacelles 130 can be configured to define an arc of 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°or the like or a range between such example values.

In one example embodiment, four nacelles 130 and four wing segments 140 can be coupled to form a 360° annular ring 145, with each of the four nacelles 130 defining an arc of 20° with each of the wing segments defining an arc of 70°. In another example, six nacelles 130 and six wing segments 140 can be coupled to form a 360° annular ring 145, with each of the four nacelles 130 defining an arc of 20° with each of the wing segments defining an arc of 40°.

In further embodiments, an annular ring 145 of an aircraft 100 can have various suitable configurations based on any suitable number of nacelles 130 and wing segments 140. Such an annular ring 145 can have any suitable configuration of arced and/or linear portions. For example, the nacelles 130 and wing segments 140 can define a fully arced 360° circle; the nacelles 130 can have linear and/or arced portions; the wing segments 140 can have linear and/or arced portions; or the like. In some embodiments, the nacelles 130 and/or wing segments 140 can be angled or V-shaped or have a portion thereof that is angled or V-shaped. In further embodiments, a plurality of nacelles 130 and wing segments 140 can define a regular polygon-shaped annular ring 145, including an annular ring 145 that defines a triangle, square, pentagon, hexagon, heptagon, octagon, nonagon, decagon, or the like.

The above embodiments are only some examples of shapes of aircraft 100 that can define a wing cavity 150 and should not be construed as limiting on the wide variety of regular or irregular shapes that an aircraft 100 of further embodiments can be, including irregular polygons, ovals, stars, clovers, hearts, and the like. Such shapes can be rounded and/or linear as discussed herein and terms such as annular, ring, or the like should not be construed to be necessarily circular, fully arced, or the like.

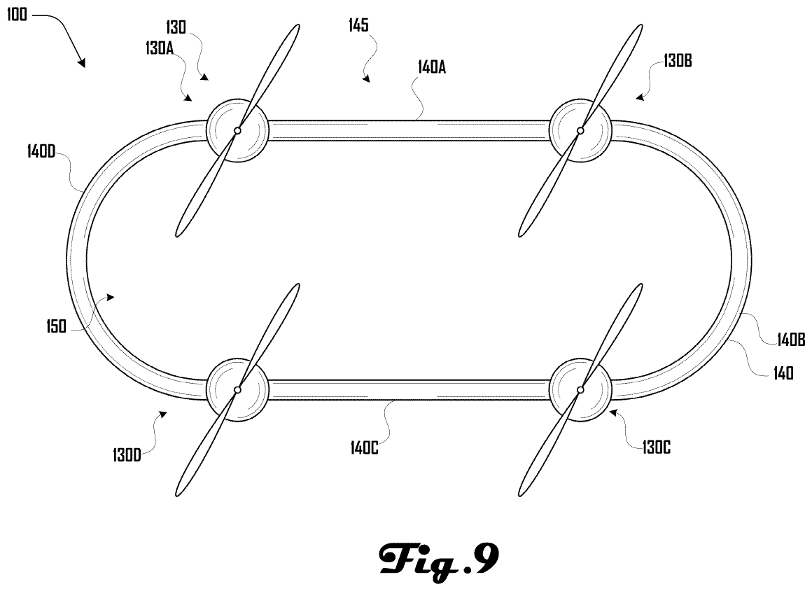

For example, FIG. 9 illustrates an example embodiment of an aircraft 100 having an annular ring 145 that defines an oval shape having an oval ring cavity 150, with the aircraft being defined by four nacelles 130A, 130B, 130C, 130D and four wing segments 140A, 140B, 140C, 140D. The first and third wing segments 140A, 140C can be linear and the second and fourth wing segments 140B, 140D can be arced (e.g., 180°). In various embodiments, such an aircraft 100 can be modular as discussed herein. For example, the first and third wing segments 140A, 140C can be swapped; the second and fourth wing segments 140B, 140D can be swapped; and/or the positions of any of the nacelles 130 can be swapped.

In various embodiments, struts 120 can extend from one or more of the nacelles 130 to a central body 110 within the ring cavity 150. In some embodiments, struts 120 can extend from a portion of a wing segment 140. Also, in some embodiments, an aircraft can include any suitable number of central bodies 110, including 1, 2, 3, 4, 5, 6, 7, 8, 9, 10 or the like. In embodiments comprising a plurality of central bodies 110 such central bodies can be coupled via one or more struts 120. Also, while various embodiments of an aircraft 100 can define a single ring cavity 150, further embodiments can define a plurality of separate cavities. For example, an aircraft 100 having a figure-eight shape can define two cavities 150; an aircraft having a clover shape can define three, four or five cavities 150, or the like. Also, in various embodiments an aircraft may lack a closed cavity 150 (e.g., have a horseshoe, partial-ring or U-shape) or be elongated such as being linear, wavy, scalloped, zig-zagged, sinusoidal, or the like.

Also, while various examples of an aircraft 100 discussed herein can include configurations where each nacelle 130 is connected to a pair of wing segments 140, in some embodiments, any suitable plurality of wing segments 140 can be coupled to a given nacelle 130 including 3, 4, 5, 6, 7, 8, 9, 10, 12, 16, 24, or the like. Also, while various embodiments illustrated herein show only couplings between nacelles 130 and wing segments 140, in some embodiments, a nacelle 130 can be connected directly to another nacelle 130 and/or a wing segment 140 can be coupled directly to another wing segment 140.

In addition to various components being modular or swappable within a single configuration, in various embodiments, a set of nacelles 130 and wing segments 140 can be configured to assume a plurality of different configurations, which may or may not include all nacelles 130 and/or wing segments 140 of the set. For example, a set of five nacelles 130 and five wing segments 140 can be configured into an aircraft 100 with five nacelles 130 and five wing segments 140 in a ring; an aircraft 100 with four nacelles 130 and four wing segments 140 in a ring; an aircraft 100 with three nacelles 130 and three wing segments 140 in a ring; an aircraft 100 with two nacelles 130 and one wing segment 140 in a linear configuration or curved; an aircraft 100 with three nacelles 130 and two wing segments 140 in a linear or curved configuration; an aircraft 100 with four nacelles 130 and three wing segments 140 in a linear or curved configuration; an aircraft 100 with five nacelles 130 and four wing segments 140 in a linear or curved configuration; or the like.

In some embodiments, nacelles 130 and/or wing segments 140 can have a static or changeable shape, size and/or coupling orientation. For example, in some embodiments, the length of a wing segment 140, or width of a nacelle 130 between coupling faces 138 can be extended/reduced (e.g., via telescoping, addition of or removal of elements, or the like). In some embodiments, the arc degree of a wing segment 140 and/or nacelle 130 can be increased/reduced. In some embodiments, the coupling angle of ends of a wing segment 140 and/or coupling faces 138 can be changed (e.g., via an axel, hinge, addition or removal of elements, or the like). Such changeable shape, size and/or coupling orientation can be desirable in various embodiments to allow a set of nacelles 130 and wing segments 140 to adapt to a variety of configurations as discussed herein.

In various embodiments, the nacelles 130 can be static, fixed or immovable; however, in some embodiments, the nacelles 130 can be configured to pitch side-to-side, pitch front-to-back, rotate forward, backward, outwardly, inwardly, and the like. For example, pitching of the nacelles 130 can include pitching by −10°, −9°, −8°, −7°, −6°, −5°, −4°, −3°, −2°, −1°, 1°, 2°, 3°, 4°, 5°, 6°, 7°, 8°, 9°, 10°, or the like, or a range between such example values.

Also, while various embodiments of an aircraft 100 define an annular ring 145 having a main ring axis (see e.g., central ring axis R of FIG. 3), further embodiments can include elements such as one or more nacelles 130 and/or wing segments 140 that extend outward from such a main axis to define a body of the aircraft that is not just planar, so the examples herein should not be construed as limiting on the wide variety of shapes or configurations that an aircraft 100 can have in accordance with further embodiments.

The aircraft 100 and components thereof described herein or utilized in the various forms of an aircraft 100 can be constructed using any suitable method and a variety of suitable materials. For example, the wing segments 140, or the like, may be fabricated from of polymer material (Abs, PETG, Nylon) by means of 3D printing. An aerodynamic surface of wing segments 140 may also be fabricated of molded or cut-to-shape foam or plastic material to form a desired shape (e.g., airfoil). In some embodiments, the wing segments 140, or the like, can be formed of a frame incorporating spars and ribs made of a variety of materials (e.g., wood, metal, polymer, composite, and the like) covered with a skin. Such a skin of a wing segment 140 can be fabricated of plastic film (e.g., mylar, vinyl, polyethylene, or the like) or woven fabric treated to make it impervious to air passing through it, or fabricated of molded or machined-to-shape polymer or composite materials. In various embodiments, other suitable manufacturing techniques (e.g., milling, routing, injection molding, 3D printing, vacuum forming, composite lay-up or any other suitable construction method) may be used to fabricate some or all the various components of an aircraft 100 discussed herein.

An aircraft 100 of various embodiments can be any suitable size and can be an unstaffed aerial vehicle (UAV), can be piloted, can be remotely piloted or can be fully or partially autonomous. For example, in some embodiments, the aircraft 100 can comprise a cockpit where one or more human users can operate the aircraft 100 or such a cockpit can be specifically absent in some embodiments. In some embodiments, the aircraft 100 can be large (e.g., with a with a diameter of 90 m, 80 m, 70 m, 60 m, 50 m, 40 m, 30 m, 20 m, or the like or a range between such values) or can be small (e.g., with a diameter of 1 ft, 2 ft, 3 ft, 4 ft, 5 ft, 6 ft, 7 ft, 8 ft, 9 ft, 10 ft, 12 ft, 15 ft, 20 ft, 25 ft, 30 ft, 35 ft, 40 ft, 45 ft, 50 ft, 55 ft, or the like or a range between such values). In some embodiments, the aircraft 100 can have a diameter of 12-14 inches.

The aircraft 100 of various embodiments can be used or configured for various suitable tasks such as picking up a payload, delivering a payload, transporting a payload, reconnaissance, military missions, transporting passengers, or the like. Payloads can be any suitable size or shape or weight and can be carried internally within the aircraft 100, suspended from the aircraft 100, disposed on top of the aircraft 100, and the like.

In various embodiments the aircraft 100 is configured to take off and/or land in a vertical attitude supported by the thrust of the motor(s) 132. Once airborne, in various examples the aircraft 100 flies in a generally horizontal attitude supported by the aerodynamic lift of the wing segment(s) 140 (e.g., based on an airfoil profile of the wing segment(s) 140).

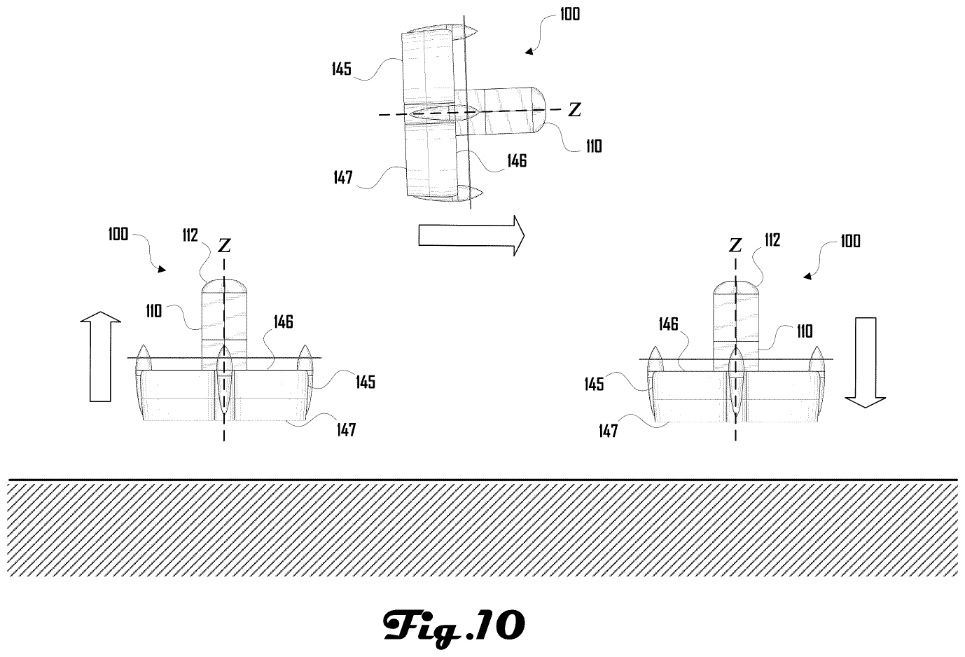

For example, FIG. 10 illustrates an example of an aircraft 100 taking off in a vertical orientation (e.g., where main axis Z of the aircraft assembly 100 is perpendicular to the ground or parallel to gravity), transitioning to a horizontal orientation for flight, and then transitioning to a vertical orientation for landing. As shown in this example, the aircraft 100 can take off in a vertical orientation with the first tip 112 of the central body 110 and the first edge 146 of the of the annular wing 145 oriented upward and the second edge 147 of the annular wing 145 oriented downward. Propulsive upward force for takeoff can be generated by the nacelles 130 of the aircraft 100, and in various embodiments, exclusively by the nacelles 130 of the aircraft 100.

When airborne, the aircraft 100 can rotate to a horizontal configuration for flight with the first tip 112 of the central body 110 and the first edge 146 of the annular wing 145 oriented forward and being the leading edges of flight, with the second edge 147 of the annular wing 145 being the trailing edge during flight. The aircraft 100 can be configured to fly with an angle of attack at various suitable horizontal angles relative to true horizontal such as −20°, −15°, −10°, −9°, −8°, −7°, −6°, −5°, −4°, −3°, −2°, −1°, 0°, 1°, 2°, 3°, 4°, 5°, 6°, 7°, 8°, 9°, 10°, 15°, 20° or the like, or a range between such values. In one preferred embodiment, the angle of attack is between 5° and 10°.

In various embodiments, the nacelles 130 of the aircraft 100 generate forward propulsion for forward flight of the aircraft 100 with the annular wing 145 generating aerodynamic lift for the aircraft 100 based on forward flight in the horizontal flight orientation. The aerodynamic lift generated by the annular wing 145 can support the weight of the aircraft 100 and can thereby reduce power required to fly in the horizontal configuration compared to power that would be required for forward flight of the aircraft 100 in the vertical orientation. For example, in various embodiments, aerodynamic lift generated by the annular wing 145 can support various amounts of the weight of the aircraft assembly 100 including at least 60%, 70%, 80%, 85%, 90%, 95%, 100%, 110%, 120%, 130% or the like, or a range between such example values.

For landing, the aircraft 100 can rotate from the horizontal configuration to a vertical orientation with the first tip 112 of the central body 110 and the first edge 146 of the annular wing 145 oriented upward and the second edge 147 of the annular wing 145 oriented downward (where main axis X of the aircraft 100 is perpendicular to the ground or parallel to gravity). The aircraft 100 can land on the ground or other surface via the second edge 147 of the annular wing 145, via landing gear on the second edge 147 of the annular wing 145, or the like. In some embodiments, an aircraft can be configured to take off, fly and/or land in an opposite orientation from the example above. Propulsive upward force for landing can be generated by the nacelles 130 of the aircraft 100, and in various embodiments, exclusively by the nacelles 130 of the aircraft 100.

In flight, the aircraft 100 can be controlled by modulating the thrust of the motor(s) 132. In wing-borne flight, the aircraft 100 turns in various embodiments by yawing, using the lateral aerodynamic force generated by the annular wing 145 to deflect the flight path. Wing-borne flight supported by the annular wing 145 can require significantly less power in some examples than rotor-borne flight supported by the thrust of the motor(s) 132.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments.

Additionally, elements that are specifically shown in example embodiments should be construed to cover embodiments that comprise, consist essentially of, or consist of such elements, or such elements can be explicitly absent from further embodiments. Accordingly, the recitation of an element being present in one example should be construed to support some embodiments where such an element is explicitly absent.

What is claimed is:

1. A modular aircraft system comprising:
a plurality of nacelles that each comprise:
a motor enclosed within a nacelle body,
a plurality of rotatable blades, and
a pair of coupling faces on opposing sides of the nacelle body;
a plurality of wing segments, with each of the wing segments having an airfoil cross section profile and defining an arc of 90°;
a central body; and
a plurality of struts,
wherein the modular aircraft system is modularly configurable into a plurality of different configurations with pairs of the plurality of nacelles connected via respective wing segments of the plurality of wing segments to generate a generally circular annular wing of 360°that defines a wing cavity, with the nacelles defining linear portions of the annular wing, with at least a first configuration of the plurality of different configurations having a first and third nacelle of the plurality of nacelles aligned along a common axis Y, with a second and fourth nacelle of the plurality of nacelles disposed along a common axis X that is perpendicular to axis Y, with four wing segments of the plurality of wing segments extending between and coupled to respective pairs of the first, second, third and fourth nacelles via the coupling faces of the respective nacelles to define the generally circular annular wing of 360°and the wing cavity,
wherein each of the plurality of different configurations include the central body disposed centrally within the wing cavity and coupled to each of the first, second, third and fourth nacelles via a respective first, second, third and fourth strut of the plurality of struts to define first, second, third and fourth wing cavity portions within the wing cavity, the central body having a main axis Z that is perpendicular to common axis X and common axis Y.

2. The modular aircraft system of claim 1, wherein the plurality of nacelles and the plurality of wing segments are configured to be readily assembled and disassembled and modularly configurable into any of the plurality of different configurations.

3. The modular aircraft system of claim 1, wherein a set of the plurality of different configurations includes the first and third nacelles of the plurality of nacelles aligned along the common axis Y, with the second and fourth nacelles of the plurality of nacelles disposed along the common axis X that is perpendicular to axis Y, with different combinations of the four wing segments of the plurality of wing segments extending between and coupled to different respective pairs of the first, second, third and fourth nacelles via the coupling faces of the respective nacelles to define the generally circular annular wing of 360° and the wing cavity.

4. The modular aircraft system of claim 1, wherein at least a second configuration of the plurality of different configurations includes the first and second nacelles of the plurality of nacelles aligned along the common axis Y, with the third and fourth nacelles of the plurality of nacelles disposed along the common axis X that is perpendicular to axis Y.

5. The modular aircraft system of claim 1, wherein the modular aircraft system in at least the first configuration is operable to:
takeoff of in a vertical orientation with the main axis Z perpendicular to the ground;
after the takeoff in the vertical orientation, rotate from the vertical orientation to a horizontal flight orientation where the main axis Z is between 0° and 15° from true horizontal;
fly from a first location to a second location in the horizontal flight orientation with a first tip of the central body and a first edge of the annular wing oriented forward and being a leading edges of flight, with a second edge of the annular wing being a trailing edge during flight, the nacelles generating forward propulsion for the forward flight and the airfoil cross section profile of the annular wing generating aerodynamic lift based on forward flight in the horizontal flight orientation, the aerodynamic lift generated by the annular wing supporting equal to or greater than 90% of the weight of the modular aircraft system in at least the first configuration and reducing power required to fly in the horizontal flight orientation compared to forward flight in the vertical orientation;
rotate from the horizontal flight orientation to the vertical orientation at the second location; and
land on the ground in the vertical orientation at the second location.

6. A modular aircraft system comprising:
a plurality of nacelles;
a plurality of wing segments, with each of the wing segments having an airfoil cross section profile and defining an arc;
a central body; and
a plurality of struts,
wherein the modular aircraft system is modularly configurable into a plurality of different configurations with pairs of the plurality of nacelles connected via respective wing segments of the plurality of wing segments to generate a generally circular annular wing of 360° that defines a wing cavity, with the nacelles defining linear portions of the annular wing,
wherein each of the plurality of different configurations include the central body disposed centrally within the wing cavity and coupled to the annular ring via the plurality of struts, the central body having a main axis Z that is perpendicular to common axis X and common axis Y.

7. The modular aircraft system of claim 6, wherein a plural set of the plurality of wing segments each define an arc of between or equal to 180° and 60°.

8. The modular aircraft system of claim 6, with at least a first configuration of the plurality of different configurations having a first and third nacelle of the plurality of nacelles aligned along a common axis Y, with a second and fourth nacelle of the plurality of nacelles disposed along a common axis X, with wing segments of the plurality of wing segments extending between and coupled to pairs nacelles of to define the generally circular annular wing of 360° and the wing cavity.

9. The modular aircraft system of claim 8, wherein the central body is coupled to each of the first, second, third and fourth nacelles via a respective first, second, third and fourth strut of the plurality of struts.

10. The modular aircraft system of claim 8, wherein at least a second configuration of the plurality of different configurations includes the first and second nacelles of the plurality of nacelles aligned along the common axis Y, with the third and fourth nacelles of the plurality of nacelles disposed along the common axis X.

11. A modular aircraft system comprising:
a plurality of nacelles; and
a plurality of wing segments;
wherein the modular aircraft system is modularly configurable into a plurality of different configurations with pairs of the plurality of nacelles connected via respective wing segments of the plurality of wing segments to generate an annular wing that defines a wing cavity.

12. The modular aircraft system of claim 11, further comprising a central body.

13. The modular aircraft system of claim 12, further comprising one or more struts that connect the central body to the annular wing.

14. The modular aircraft system of claim 12, wherein one or more of the plurality of different configurations include the central body disposed centrally within the wing cavity.

15. The modular aircraft system of claim 11, wherein each of the wing segments having an airfoil cross section profile.

16. The modular aircraft system of claim 11, wherein a plural set of the plurality of wing segments each define an arc of between or equal to 180° and 60°.

17. The modular aircraft system of claim 11, wherein the annular wing is a generally circular annular wing of 360°.

18. The modular aircraft system of claim 11, wherein the nacelles define linear portions of the annular wing.

19. The modular aircraft system of claim 11, with at least a first configuration of the plurality of different configurations having a first and third nacelle of the plurality of nacelles aligned along a common axis Y, with a second and fourth nacelle of the plurality of nacelles disposed along a common axis X, with wing segments of the plurality of wing segments extending between and coupled to pairs nacelles of to define the annular wing.

20. The modular aircraft system of claim 19, wherein at least a second configuration of the plurality of different configurations includes the first and second nacelles of the plurality of nacelles aligned along the common axis Y, with the third and fourth nacelles of the plurality of nacelles disposed along the common axis X.
